(19) United States
(12) Patent Application Publication
(10) Pub. No.: US 2006/0048759 A1
(43) Pub. Date: Mar. 9, 2006

(54) Device for exchanging heat

(75) Inventors: Daniel Hendrix, Stuttgart (DE); Florian Moldovan, Stuttgart (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/542,410

(22) PCT Filed: Nov. 7, 2003
(86) PCT No.: PCT/EP03/12468

§ 371 Date: Jul. 15, 2005

(30) Foreign Application Priority Data
Jan. 23, 2003 (DE) 103027084

(51) Int. Cl. F02B 33/00; F28D 7/10

(52) U.S. Cl. 123/563; 165/157; 165/159

(57) ABSTRACT

Disclosed is a device for exchanging heat, especially for cooling the combustion air of internal combustion engines in motor vehicles, which is characterized by the fact that the flow devices (14) are accommodated in a profiled housing (6) comprising at least two parts. The cross section of a first housing part (6a) is essentially U-shaped, said basic shape being closed at the open end of the first housing part (6a) by means of a second, substantially planar housing part (6b). The inventive device is further characterized by the fact that the housing (6) comprises at least one inlet flange and at least one outlet flange for the second medium at two opposite side while the flow devices (14) are kept at a distance from each other in at least one area by means of at least one frame device (12) which is accommodated within the housing (6).

The invention relates to a device for exchanging heat, in particular for cooling the combustion air of internal combustion engines in motor vehicles. Such devices for exchanging heat, which are also referred to as charge air coolers, are used to cool the combustion air of an internal combustion engine. However, the invention can also be applied to other heat exchangers.

In this context, combustion air, which has a high temperature level due to compression, is directed through the device and cooled down using a refrigerating agent, which also flows through the device. DE 199 27 607 discloses devices in which the combustion air is directed through the device through a plurality of pipes in order to exchange heat and which have a feed means and a discharge means for a refrigerating agent, as a result of which this refrigerating agent flows around the pipes. In order to ensure that between the pipes there are distances through which the refrigerating agent can flow, in the prior art the ends of the pipes are widened so that the pipes are each respectively spaced apart from one another.

However, this method of manufacture has the disadvantage that the individual pipes have to be aligned very precisely with one another and the soldering together of the device is technically very complex. In addition, it is known to construct the housing of such devices from two components, for example in such a way that it has a U-shaped base body as well as a cover which is inserted into this base body. However, this procedure has the disadvantage that the cover can move in relation to the base, which adversely effects the fabrication precision.

The object of the present invention is therefore to make available an improved device which has the purpose of exchanging heat and which can, in particular, be manufactured cost-effectively.

This object is achieved according to the invention by means of the subject matter of the main claim 1. Advantageous embodiments are the subject matter of the subclaims.

The subject matter of the present invention is a device for exchanging heat, in particular for cooling the combustion air of internal combustion engines in motor vehicles, which device has at least one feed means and one discharge means of a first medium, such as, for example, a refrigerating agent, coolant or some other medium, and at least one feed means and one discharge means of a second medium such as, for example, combustion air, exhaust gas or some other medium. In addition, at least one flow device is provided for the refrigerating agent and at least one flow device is provided for the combustion air, wherein the flow paths of the flow devices of a refrigerating agent and of the combustion air are separated from one another and the flow directions are at least partially different.

A flow device is understood here to be a device which spatially separates the flowing medium, for example, pipes, in particular flat pipes and the like. The device can have a plurality of components.

The term flow device is also understood to refer to the intermediate space between two bodies, which intermediate space forms a flow path if a medium can flow in it. For example, the region between two flat pipes is to be considered to be a flow device.

A refrigerating agent is to be understood generally as any gaseous or liquid medium which has a lower temperature than the medium to be cooled, i.e. the combustion air. Refrigerating agents include, in particular, water, possibly with additives such as glycol, in particular from the cooling circuit, so that water is also used below in place of refrigerating agent.

The flow path of a medium is to be understood as the path within a flow device which the refrigerating agent travels along, for example, between the feed means and the discharge means within the device for cooling combustion air.

The flow direction is the direction of flow which the medium, that is to say the refrigerating agent or the combustion air, takes within the flow devices for cooling combustion air, at least over a specific time period.

The invention is also characterized in that the flow devices are accommodated in an at least two-component, contoured housing, wherein a first housing component has an essentially U-shaped outline cross section which is closed by a second, essentially planar housing component at the open side of the first housing component.

The housing of the device also has at least one inlet flange and at least one outlet flange for the combustion air on two opposite sides.

The flow devices for the combustion air and/or the refrigerating agent are held spaced apart from one another in at least one region by means of at least one frame device which is accommodated in the housing.

A two-component housing is to be understood as meaning that the housing is not manufactured from one basic body but rather has two separate components which are combined, and in particular connected, to one another.

Contoured is to be understood as meaning that the edges at which the component of the housing are joined to one another do not extend linearly but rather deviate from this in a specific way. For example, in one component of the housing it is possible to provide notches or grooves in which projections of the second component of the housing engage. In addition, it is also possible to provide projections which have any desired geometrical shape and which engage in corresponding recesses of the corresponding, other component of the housing.

In the present invention, a U-shaped outline is to be understood as meaning shapes whose cross section is described essentially by a rectangle in which one of the four sides is missing. However, in such a case the individual corners may also be rounded or one side may be made circular or ellipsoidal. The profile of the individual side does not necessarily have to be linear either.

The term “U-shape” in the present invention also describes configuration shapes in which a longer side of the rectangle is in the cross section of the omitted side.

Finally, shapes which have essentially an ellipsoidal cross section are also included, in which case a segment is cut out of this ellipse.

A flat component of the housing is understood to be a component of the housing which extends essentially in two dimensions, that is to say forms essentially one plane.

A frame device in the sense of the present invention is understood to be any device which is suitable for keeping flow devices at a predefined distance from one another.

In one preferred embodiment, at least component of the two-component housing has the feed means and the discharge means for the refrigerating agent.

The feed means and discharge means for the refrigerating agent are preferably arranged on the same side of the housing. Alternatively, the feed means and the discharge means for the refrigerating agent may be arranged on different, in particular opposite, sides of the housing. The feed means and discharge means may be arranged at the same height or at different heights on the housing. A duel inflow and/or outflow may also be provided.

In one embodiment, the feed means and the discharge means for the refrigerating agent are arranged in the vicinity of two corners of the device, in which case the connection of these corners is the spatial diagonal of the device.

The flow devices of the combustion air are preferably flat pipes. A flat pipe is understood here to be a pipe which has a specific width and a low height in comparison with this width. These flat pipes may have a rectangular, ellipsoidal or similar cross section. Flat pipes of the flow device of the combustion air are preferably essentially arranged parallel to one another.

The flow device of the refrigerating agent preferably has turbulence devices such as, for example, turbulence grills or plates, patterned surfaces, turbulence generators etc.

The term patterned surfaces is to be understood here as meaning that the surfaces are not smooth but rather have projections, channels, lugs or similar devices which increase the turbulence of the medium flowing past them and thus improve the transfer of heat between the wall and the medium.

The flow device of the refrigerating agent preferably has dividing elements which define at least one predetermined flow path for the refrigerating agent. However, this is not to be understood in particular as meaning exclusively that the refrigerating agent cannot pass from the inlet to the outlet over the shortest path but rather that these separating means cause the refrigerating agent to flow through essentially the entire region of the housing. What is referred to as positive guidance may also be understood by this.

The components of the devices such as, for example, the flow devices, the housing, the feed means and discharge means for the refrigerating agent, the inlet flange and outlet flange for the combustion air etc. are preferably manufactured from at least one material which is selected from a group of materials which contains metals such as aluminum, iron, brass, copper, titanium etc., metal alloys such as aluminum alloys, iron alloy etc., plastics such as PVC, PU, duroplastics, fiber-reinforced plastics etc.

In the preferred embodiment, the first housing component forms essentially three contoured side faces of a cube, wherein the orientation of the contouring assumes a predefined angle with respect to a main direction of flow of the combustion air.

A contoured side face is in turn to be understood as meaning that the side face is not a smooth face but rather has predefined deviations from a smooth surface.

The second housing component preferably has an external contour which is adapted to the profile contour of the first housing component. This ensures that the second component of the housing can be fitted precisely into a face which is predefined by the contouring elements of the first component of the housing.

In one preferred embodiment, the inlet flange and outlet flange are constructed from at least two components and they close off the housing at two opposite end sides of the cube in a gas-tight and/or liquid-tight fashion. The inlet flange and/or the outlet flange preferably have a deep-drawn base body with a bushing which accommodates a predefined distance of a pipe, in particular of a connecting pipe, or fits into it. For this purpose, the inlet or outlet flange can also have an elevated portion such as a bead, which improves the connection to a further pipe.

Preferably, the feed means and the discharge means for the refrigerating agent are provided as bushings in the housing which accommodate the predefined section of a pipe, in particular of a connecting pipe, or fit into it. Here too, elevated portions or beads which facilitate connection to a connecting pipe may also be provided on the feed means.

The second housing component, the boundary element and the flanges preferably form a gas-tight and/or liquid-tight termination of the end sides of the housing.

In a further preferred embodiment, at least two frame devices are provided which keep at least the flat pipes of the flow device of the combustion air spaced apart. Here, the frame devices are preferably arranged in the vicinity of the ends of the flat pipes. However, other arrangements of the frame devices are also conceivable. In particular it is conceivable for a frame device to function simultaneously as a dividing element in order to permit the refrigerating agent to be distributed essentially over the entire interior of the refrigerating agent flow device.

The frame device is preferably an essentially planar plate which has a predefined number of bushings for accommodating the flat pipes. These bushings have a cross section which corresponds essentially to the cross section of the flat pipes or is slightly larger than said cross section.

In one particularly preferred embodiment, the frame device and the flat pipes are connected to one another in a gas-tight and/or liquid-tight fashion.

In addition, a materially joined, frictionally locking and/or positively locking connection is preferably provided between the components of the device. In one preferred embodiment the components of the device for exchanging heat may be connected by means of a soldered connection in this context.

In a further preferred embodiment, the frame device is a plate with upturned edges which are connected, in particular, to at least one section of the internal contour of the housing. However, instead of the upturned edges, the frame device can also have a drawn, edged or rounded edge.

The present invention is also directed at internal combustion engines having an exhaust gas turbocharger or compressor which have at least one device for exchanging heat according to the present invention.

The present invention is also directed at a method for exchanging heat, in particular for cooling combustion air, in particular for charge air of internal combustion engines, wherein, in a first method step, combustion air is introduced at a temperature T1 in a first flow path, of the device according to the invention, wherein, in a second method step, a refrigerating agent with a temperature T2 is directed into a second flow path of the same device, it is heat transferred between the combustion air and the refrigerating agent in a further step, and wherein finally the combustion air is carried away at a temperature T3, wherein the temperature T1 is higher than the temperature T3, and the temperature T3 is higher than the temperature T2.

Further advantages and refinements of the present invention emerge from the appended figures, of which:

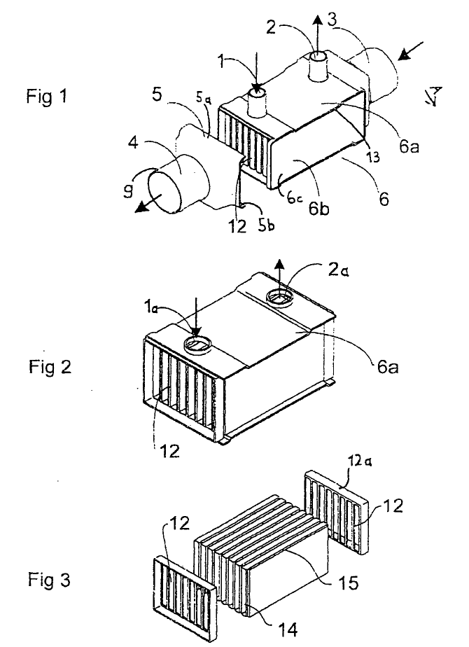

FIG. 1 shows a heat exchanger according to the invention according to a first embodiment;

FIG. 2 shows a detailed view of the heat exchanger according to the invention from FIG. 1;

FIG. 3 shows a detailed view of the heat exchanger from FIGS. 1 and 2;

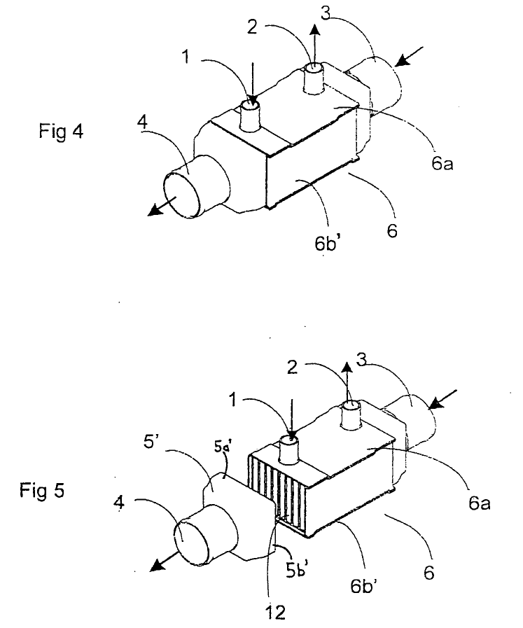

FIG. 4 shows a heat exchanger according to the invention according to a further embodiment in the assembled state;

FIG. 5 shows a heat exchanger according to the invention from FIG. 4 in a partially exploded view;

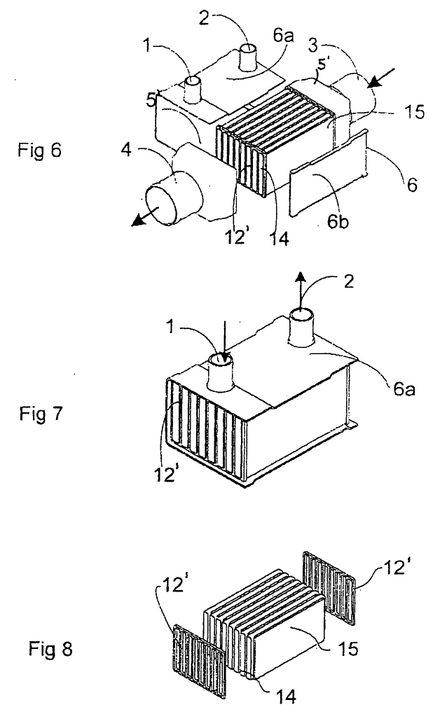

FIG. 6 shows the heat exchanger according to the invention from FIG. 4 in a further exploded view;

FIG. 7 shows a detailed view of the heat exchanger according to the invention from FIG. 4;

FIG. 8 shows a detailed view of the heat exchanger according to the invention from FIGS. 4 to 7;

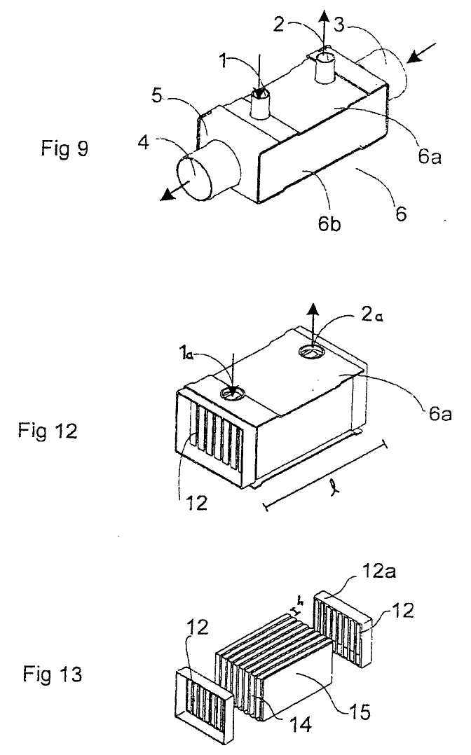

FIG. 9 shows a heat exchanger according to the invention according to a further embodiment in the assembled state;

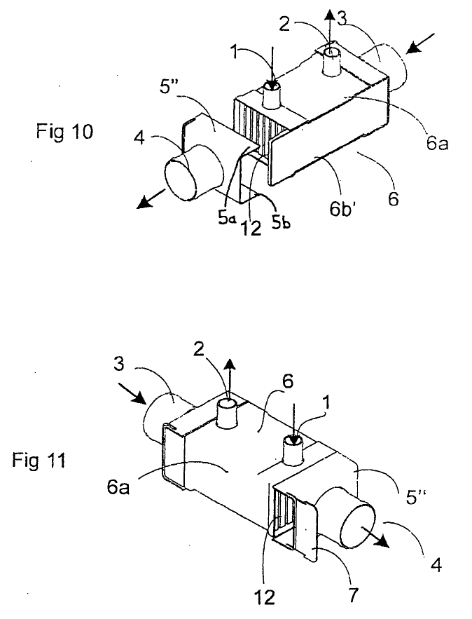

FIG. 10 shows the heat exchanger according to the invention as in FIG. 9 in a partially exploded view;

FIG. 11 shows an illustration of the heat exchanger from FIG. 10 from another perspective;

FIG. 12 shows a detailed view of the heat exchanger from FIG. 9; and

FIG. 13 shows a detailed view of the heat exchanger from FIGS. 9 to 12.

FIG. 1 shows a heat exchanger according to the invention in a partially exploded view. The reference numbers 1a and 1b relate to a feed means and a discharge means for a refrigerating agent.

This refrigerating agent is preferably water, in particular water with additives, for example glycol, from the cooling circuit. However it is also possible to provide other refrigerating agents, either in a gaseous or liquid phase.

The reference numbers 3 and 4 relate to a feed means and a discharge means for the combustion air, that is to say for the air to be cooled. The feed means and discharge means are embodied in the form of inlet and outlet flanges which can each be connected to a further feed line. These connections can either be formed by a pipe with relatively large circumference being fitted over the flanges or a pipe with relatively small circumferences being inserted into the opening. A bead 9 which permits a more stable connection between the feed line pipe and the flange can preferably be provided on the respective flanges.

The reference number 12 designates a frame device whose function will be described in more detail below. The reference number 6 relates to a housing for the device for exchanging heat. The feed means and discharge means for the refrigerating agent and the feed means and discharge means for the combustion gas as well as the cover device 5 and the cover device lying opposite are not components of this housing.

In this embodiment the housing is composed of a first component 6a which is essentially in the shape of a U. In FIG. 1, the open side of this U is pointing in the direction of the arrow A. In addition, the housing has a second component 6b which is embodied here as a cover which covers that side of the U-shaped, first component which is open at the top.

The U-shaped, first component has contouring elements 13 into which the second component with corresponding contouring elements is fitted.

In FIG. 1, the second housing component 6b is embodied essentially in the form of a rectangle which has counter sunk sections on its longer sides.

FIG. 2 shows a detailed view of the device for exchanging heat which is shown in FIG. 1. Reference numbers 1a and 2a relate to flanges in which the feed means and the discharge means for the refrigerating agent 1 and 2 can be inserted. The reference number 6a relates in turn to the first U-shaped component of the housing which has a profile structure. The second component, that is to say the cover of the housing, has however been omitted from this drawing. The reference number 12 indicates the frame device again.

FIG. 3 shows, as a further detailed view, the interior of the housing 6 of the device for exchanging heat from FIG. 1. Flat pipes 14 through which the combustion air flows are arranged inside the housing 6. Contoured plates 15 are arranged between the individual flat pipes.

Contouring is understood to be countersunk portions, elevated portions, furrows and the like. The devices 15 are preferably also turbulence devices such as turbulence grills or plates, patterned surfaces, turbulence generators or the like.

The frame device 12 serves to keep the individual flat pipes 14 at a predetermined distance. The frame device 12 has an edge 12a so that a more stable connection can be brought about between the frame and the housing.

During operation, the refrigerating agent flows out of the cooling circuit into the device through the feed means 1. Here, the refrigerating agent is essentially distributed over the entire spatial content of the housing, with the contouring elements of the devices 15 improving the transfer of heat with the flat pipes. Finally, the refrigerating agent is discharged from the device again via the discharge means 2.

The cover 5 which bears the discharge means for the combustion gas has edges 5a and 5b only on three side edges, with the third side edge bearing against the side facing away from the viewer. On the fourth side, a proceeding component 6c of the housing component 6b is inserted into the cover 5.

FIG. 4 shows a device according to the invention for transferring heat in a further embodiment, in the assembled state. The reference numbers 1 and 2 relate in turn to a feed means and a discharge means for the refrigerating agent. The reference numbers 3 and 4 refer to feed means and discharge means for the combustion gas. The arrows each present the directions of flow of the combustion air and of the refrigerating agent. The housing has in turn a first U-shaped component 6a, and a second component in the form of a cover 6b′. In contrast to the embodiment shown in FIG. 1, the second component, that is to say the cover does not project beyond the U-shaped, first component in the lateral direction, i.e. a section 6c is not present here.

FIG. 5 shows a partially exploded view of the device for exchanging heat which is shown in FIG. 4. It is apparent that the second component, that is to say the cover 6b′, adjoins the first component 6a at the same height. In contrast to the cover of the combustion gas discharge means 5, the cover of the combustion gas discharge means 5′ has four edges 5a′, 5b′, 5c′, 5d′ (5c′ and 5d′ not shown) which project laterally in the same way.

FIG. 6 shows an exploded view of the device shown in FIG. 4. It is apparent that the flat pipes 14 are pushed through the frame device 12. The second component of the housing, that is to say the cover 6b, has in turn contoured elements which are adapted to the corresponding contoured elements of the first component of the housing 6a. When the device is assembled, the cover device 5 is pushed over the frame 12. The cover for the combustion air feed means and the cover for the combustion air discharge means are preferably formed in the same way.

FIG. 7 shows a detailed view of the device from FIG. 6. The second housing component 6b has been omitted in order to permit a clear view of the interior of the housing.

FIG. 8 shows a further detail of the device for exchanging heat. The refrigerating agent flows in the same way here as in the case of the first embodiment and is therefore not described in more detail. In contrast to the frame device in the first embodiment, the frame device 12′ is not provided with edges here but rather is of essentially two-dimensional design. In this exemplary embodiment, the devices 15, which are referred to below as turbulence generators, are also present again.

However, it is also possible, instead of these turbulence generators, to leave free spaces between the flat pipes between which the refrigerating agent can flow in an essentially unimpeded fashion. In the present embodiment, the device is designed on the basis of the counterflow principle, that is to say the feed means for the refrigerating agent lies on the same side as the discharge means for the combustion air and the discharge means for the refrigerating agent lies on the same side as the feed means for the combustion air. However, it is also possible to interchange the position of the feed means and discharge means for the refrigerating agent and feed means and discharge means for the combustion gas.

Length I of the device lies between 50 mm and 600 mm, in particular between 100 mm and 600 mm, preferably between 150 mm and 500 mm, and more preferably between 200 mm and 400 mm. The height h of the flat pipes is between 2 mm and 40 mm, in particular between 4 mm and 10 mm, preferably between 7.5 mm and 8.5 mm.

FIG. 10 illustrates a further embodiment of the device according to the invention for exchanging heat. The essential difference from the embodiment described above is the configuration of the second housing component 6b′, that is to say of the cover, and in the configuration of the cover device 5″. The cover device 5′ is formed from a simple contour and therefore has only two side walls 5a and 5b. The second component of the housing 6b′ is inserted into one of the intermediate spaces between the side walls 5a and 5b′.

FIG. 11 shows a representation of the device from FIG. 10 from another perspective. Since the cover 5″ has only two side walls and only one side wall is replaced by the second component of the housing 6b′, a device is necessary to close the remaining opening. This is done by means of a panel 7 which is inserted into the last side wall. The corresponding cover for the feed means of the combustion gas 3 is of corresponding design. However it is to be noted that the two covers for the feed means and the discharge means of the combustion gas are preferably embodied in the same way, but this is not necessarily the case. For example, covers of different embodiments may be combined with one another.

FIG. 9 shows the device according to the invention for exchanging heat according to the third embodiment in the assembled state.

FIG. 12 is a detailed view of the device according to the invention for exchanging heat shown in the third embodiment. As is apparent from FIG. 12 and FIG. 13, the frame devices 12 and 12a are fitted onto the respective ends of the flat pipes 14.

1. A device for exchanging heat, in particular for cooling the combustion air of internal combustion engines in motor vehicles with at least one feed means and one discharge means of a first medium such as a refrigerating agent, and at least one feed means and one discharge means of a second medium, such as the combustion air, at least one flow device for the first medium, such as the refrigerating agent, and one flow device for the second medium, such as the combustion air, wherein the flow paths of the flow devices of the first medium and of the second medium are separated from one another and the flow directions are at least partially different, characterized in that the flow devices are accommodated in an at least two-component, contoured housing, wherein a first housing component has an essentially U-shaped outline cross section which is closed by a second, essentially planar housing component at the open side of the first housing component, and in that the housing has, on two opposite sides, at least one inlet flange and at least one outlet flange for the second medium, and in that the flow devices are held spaced apart from one another in at least one region by means of at least one frame device which is accommodated in the housing.

2. The device for exchanging heat as claimed in claim 1, characterized in that at least component of the two-component housing has the feed means and the discharge means for the first medium, such as the refrigerating agent.

3. The device for exchanging heat, in particular as claimed in claim 1, characterized in that the feed means and the discharge means for the first medium, such as the refrigerating agent, are arranged on the same side of the housing.

4. The device for exchanging heat, in particular as claimed in claim 1, characterized in that the feed means and the discharge means for the first medium, such as the refrigerating agent, are arranged on different, in particular opposite, sides of the housing.

5. The device as claimed in claim 1, characterized in that a single or double feed means and/or discharge means is provided for the first medium, such as the refrigerating agent.

6. The device for exchanging heat, in particular as claimed in claim 1, characterized in that the flow devices of the second medium, such as the combustion air, for example, are flat pipes.

7. The device for exchanging heat, in particular as claimed in claim 1, characterized in that the flat pipes of the flow device of the second medium, such as the combustion air, are essentially arranged parallel to one another.

8. The device as claimed in claim 1, characterized in that the flat pipes are arranged in one, two or more rows of parallel pipes, wherein the rows of flat pipes are arranged parallel to one another and/or in series with one another.

9. The device as claimed in claim 1, characterized in that the respective rows of flat pipes comprise a predefinable number of pipes.

10. The device for exchanging heat, in particular as claimed in claim 1, characterized in that the flow device of the first medium, such as the refrigerating agent, has turbulence devices such as, for example, turbulence grills or plates, patterned surfaces, turbulence generators etc.

11. The device as claimed in claim 1, characterized in that the drop in pressure in the region of the turbulence devices in the main direction of flow is greater than perpendicularly to the main direction of flow.

12. The device for exchanging heat, in particular as claimed in claim 1, characterized in that the flow device of the first medium, such as the refrigerating agent, has flow paths which are determined essentially by the distance between the flat pipes of the combustion air and/or the distance from the housing and/or by the turbulence devices.

13. The device for exchanging heat, in particular as claimed in claim 1, characterized in that the flow device of the first medium, such as the refrigerating agent, has dividing elements which define at least one predetermined flow path for the first medium.

14. The device for exchanging heat, in particular as claimed in claim 1, characterized in that the components of the devices such as, for example, the flow devices, the housing, the feed means and discharge means for the first medium, the inlet flange and outlet flange for the second medium etc. are manufactured from at least one material which is selected from a group of materials which contains metals such as aluminum, iron, brass, copper, titanium etc., metal alloys such as aluminum alloy, iron alloys, etc., plastics PVC, PU, duroplastics, fiber-reinforced plastics, etc.

15. The device for exchanging heat, in particular as claimed in claim 1, characterized in that the first housing component forms essentially three contoured side faces of a cube, wherein the orientation of the contouring assumes a predefined angle with respect to the main direction of flow of the second medium.

16. The device for exchanging heat, in particular as claimed in claim 1, characterized in that the second housing component has an external contour which is adapted to the profile contour of the first housing component.

17. The device for exchanging heat, in particular as claimed in claim 1, characterized in that the inlet flange and outlet flange have at least two components, and the housing is closed off on two opposite end sides of the cube in a gas-tight and/or liquid-tight fashion.

18. The device for exchanging heat, in particular as claimed in claim 1, characterized in that the inlet flange and/or the outlet flange have a deep-drawn base body with a bushing which accommodates a predefined section of a pipe, in particular of a connecting pipe, or fits into it.

19. The device for exchanging heat, in particular as claimed in claim 1, characterized in that the feed means and the discharge means for the first medium are bushings in the housing which accommodate a predefined section of a pipe, in particular of a connecting pipe, or fit into it.

20. The device for exchanging heat, in particular as claimed in claim 1, characterized in that the inlet flange and/or the outlet flange has a base body which is bent on at least two sides, in particular in the shape of a U, and has a bushing which accommodates a predefined section of a pipe, in particular of a connecting pipe, or fits into it, and has at least one further bushing for accommodating a boundary element.

21. The device for exchanging heat, in particular as claimed in claim 1, characterized in that the second housing component, the boundary element and the flanges form a gas-tight and/or liquid-tight termination of the end sides of the housing.

22. The device for exchanging heat, in particular as claimed in claim 1, characterized in that at least two frame devices are provided which keep at least the flat pipes of the flow device of the second medium spaced apart.

23. The device for exchanging heat, in particular as claimed in claim 1, characterized in that the frame device is an essentially planar plate which has a predefined number of bushings for accommodating the flat pipes.

24. The device for exchanging heat, in particular as claimed in claim 1, characterized in that the frame device and the flat pipes are connected in a gas-tight and/or liquid-tight fashion.

25. The device for exchanging heat, in particular as claimed in claim 1, characterized in that a materially joined, frictionally locking and/or positively locking connection is provided between the components of the device.

26. The device for exchanging heat, in particular as claimed in claim 1, characterized in that the components of the device for exchanging heat are connected by means of a soldered connection.

27. The device for exchanging heat, in particular as claimed in claim 1, characterized in that the frame device is a plate with upturned edges which are connected, in particular, to at least one section of the internal contour of the housing.

28. The device for exchanging heat, in particular as claimed in claim 1, characterized in that the turned up edges of the frame device have sharply edged or rounded corners.

29. Internal combustion engines having an exhaust gas turbocharger which has at least one device for exchanging heat as claimed in claim 1.
